(19) United States
(12) Patent Application Publication
(10) Pub. No.: US 2026/0170825 A1
(43) Pub. Date: Jun. 18, 2026

(54) METHOD AND APPARATUS FOR ACQUIRING STEREOGRAM PRINTING CONTENT USING DRONE

(71) Applicant: KWANGWOON UNIVERSITY INDUSTRY-ACADEMIC COLLABORATION FOUNDATION, Seoul (KR)

(72) Inventors: Lee Hwan HWANG, Seoul (KR); Seung Hyun LEE, Seoul (KR); Jin Won CHOI, Seoul (KR)

(21) Appl. No.: 19/091,620

(22) Filed: Mar. 26, 2025

(30) Foreign Application Priority Data
Dec. 17, 2024 (KR) 10-2024-0187911

(51) Int. Cl. G06V 20/17; B64C 39/02; G06T 3/40; G06T 7/246; G06V 10/24; H04N 23/68

(52) U.S. Cl. CPC G06V 20/17; B64C 39/024; G06T 3/40; G06T 7/246; G06V 10/24; H04N 23/683; G06T 2207/20132

(57) ABSTRACT

The present disclosure is a stereogram printing content acquiring method which is performed in a stereogram printing content acquiring apparatus, including (a) a step of receiving a continuous image which is obtained by capturing a photographic subject using a drone equipped with a camera; (b) a step of adjusting a size to make a size of the photographic subject in the continuous image constant; (c) a step of correcting shake of a continuous image with an adjusted size; and (d) a step of correcting an error of a rotational center axis of the continuous image in which the shake is corrected.

### CROSS-REFERENCE TO RELATED APPLICATIONS

This application claims the priority of Korean Patent Application No. 10-2024-0187911 filed on Dec. 17, 2024, in the Korean Intellectual Property Office, the disclosure of which is incorporated herein by reference.

### BACKGROUND

### Field

The present disclosure relates to a technology for acquiring a stereogram printing content, and more particularly, to a method and an apparatus for acquiring a stereogram printing content using a drone which use a drone to move camera while maintaining a predetermined radius from an object to take a picture and correct the captured image to be used as a Multiview projection image.

### Description of the Related Art

Hologram is an imaging technology which allows the virtual to be perceived as the real and is being studied and developed a lot and is also being used in various fields. In order to produce a hologram, a beam splitter divides a beam emitted from a laser which is a light source into two pieces and one piece is directed to a reflective mirror and the other piece is directed to a subject to record an interference pattern generated by overlapping light (object beam) irregularly reflected from the subject and light (reference beam) reflected from the reflective mirror, on a holographic medium.

The digital holographic printing technology may be largely divided into a holographic stereogram printing technology and a holographic wavefront printing technology. According to holographic stereogram printing, after configuring a Multiview projection image having a parallax in a vertical and horizontal directions as an object beam, an interference pattern with a reference beam is formed to record on a photosensitive medium and one hologram is printed as one unit hologram which serves as a lens, using the recording method as described above. That is, a plurality of perspective projection images for a 3D object is acquired and recorded on a hologram recording medium to display a Multiview image by a holographic recording technology.

The Multiview projection image required to produce a holographic stereogram may be obtained by utilizing 3D computer rendering or actual images. At this time, in order to obtain actual images, a constant distance between a camera and a subject needs to be maintained and the camera needs to be disposed to be directed to a center of the set subject. However, it may be difficult to maintain a constant distance from a large and tall object due to physical limitations.

### [Related Art Document]

### [Patent Document]

Korean Patent Application Laid-Open No. 10-2022-0075116

### SUMMARY

An object of the present disclosure is to provide a method and apparatus for acquiring a stereogram printing content which perform 3D data modeling by ensuring an overlapping image which is easily detected regardless of the change in size or direction of an object using a smart flight mode of a drone.

An object of the present disclosure is to provide a method and apparatus for acquiring a stereogram printing content which precisely correct the continuous image by the post processing, with respect to the problems such as an imbalanced distance between a camera and a subject or camera shake.

An object of the present disclosure is to provide a method and apparatus for acquiring a stereogram printing content which restore 3D data by performing processes, such as point cloud generation, 3D mesh construction, and texture mapping by utilizing photogrammetry based on a corrected image.

In order to achieve the above-described objects, according to a first aspect of the present disclosure, a stereogram printing content acquiring method which is performed in a stereogram printing content acquiring apparatus including: (a) a step of receiving a continuous image which is obtained by capturing a photographic subject using a drone equipped with a camera; (b) a step of adjusting a size to make a size of the photographic subject in the continuous image constant; (c) a step of correcting shake of a continuous image with an adjusted size; and (d) a step of correcting an error of a rotational center axis of the continuous image in which the shake is corrected.

Desirably, the step (a) may include: a step of receiving a continuous image which is obtained by manually capturing a front surface, a top surface, and a bottom surface of the photographic subject using the drone; and a step of receiving a continuous image which is manually captured along left, center, and right trajectories on the bottom surface.

Desirably, the step (a) may include: a step of receiving continuous images which are obtained by automatically capturing the photographic subject using a point of interest (POI) flight mode of the drone while rotating with a constant distance from the photographic subject.

Desirably, the step (b) may include: a step of comparing images at a left side, a center, and a right side of the photographic subject; a step of finding a timing where a size of the photographic subject is changed on the image; and a step of adjusting a size of the photographic subject by adding a key frame to a found timing.

Desirably, the step (c) may include a step of analyzing a movement of the drone by analyzing a difference between frames of the continuous image; and a step of realigning and modifying a frame of the continuous image according to the analyzed movement.

Desirably, the step of analyzing the movement may include: a step of tracking a feature point in the continuous image; a step of calculating a relative positional change of the feature point between frames of the continuous image; and a step of predicting translation, rotation, and enlargement or reduction generated due to the shake of the drone in accordance with the calculated positional change.

Desirably, the step of realigning and modifying a frame may include: a step of translating the frame to an opposite direction by a translated amount when the analyzed movement corresponds to the translation; and a step of moving the frame to an opposite direction by an translated amount, correcting the rotation by an angle at which the frame rotates, and correcting the change of the enlargement or reduction of the frame when the analyzed movement corresponds to translation, rotation, and enlargement, or reduction respectively.

Desirably, the step of realigning and modifying a frame may include: a step of distorting and correcting the frame using perspective when the analyzed movement corresponds to perspective; and a step of independently correcting each area of the frame when the analyzed movement corresponds to a subspace distortion.

Desirably, the step (c) further includes: a step of setting a smoothness level corresponding to a degree of correction of shake and the step of setting a smoothness level may include: a step of generating an ideal path according to shake data acquired based on the analyzed movement; and a step of adjusting a movement of the drone along the ideal path.

Desirably, the step (c) includes: a step of processing an empty space caused by realignment or distortion of the frame, the step of processing an empty space may include: a step of cropping the empty space, enlarging an entire space as much as the empty space, filling the empty space with surrounding pixels, or interpolating the empty space based on data of preceding and subsequent frames.

Desirably, the step (d) may include: a step of setting a tracker to a target which is commonly seen from a first part and a last part of a center axis of the continuous image; a step of tracking a target at which the tracker is set as the continuous image is reproduced; a step of performing correction on a y-axis direction to make the center axis consistent according to the tracked result; and a step of performing rendering after performing the correction.

In order to achieve the above-described objects, according to a second aspect of the present disclosure, a stereogram printing content acquiring apparatus includes an image receiving unit which receives a continuous image which is obtained by capturing a photographic subject using a drone equipped with a camera; a size adjusting unit which adjusts a size to make a size of the photographic subject in the continuous image constant; a shake correcting unit which corrects shake of a continuous image with an adjusted size; and a center axis correcting unit which corrects an error of a rotational center axis of the continuous image in which the shake is corrected.

Desirably, the image receiving unit receives a continuous image which is obtained by manually capturing a front surface, a top surface, and a bottom surface of the photographic subject using the drone or may receive continuous images which are obtained by automatically capturing the photographic subject using a point of interest (POI) flight mode of the drone while rotating with a constant distance from the photographic subject.

Desirably, the size adjusting unit compares images at a left side, a center, and a right side of the photographic subject, finds a timing on the image where a size of the photographic subject is changed, and may adjust a size of the photographic subject by adding a key frame to a found timing.

Desirably, the shake correcting unit analyzes a movement of the drone by analyzing a difference between frames of the continuous image and may realign and modify a frame of the continuous image according to the analyzed movement.

Desirably, the shake correcting unit sets a smoothness level corresponding to a correction degree of shake, and the smoothness level may be set by generating an ideal path according to shake data acquired based on the analyzed movement and adjusting a movement of the drone along the ideal path.

Desirably, the shake correcting unit processes an empty space caused by realignment or distortion of the frame and the empty space is processed by cropping the empty space, enlarging an entire space as much as the empty space, filling the empty space with surrounding pixels, or interpolating the empty space based on data of preceding and subsequent frames.

Desirably, the center axis correcting unit sets a tracker to a target which is commonly seen from a first part and a last part of a center axis of the continuous image, tracks a target at which the tracker is set as the continuous image is reproduced, performs correction on a y-axis direction to make the center axis consistent according to the tracked result, and may perform rendering after performing the correction.

In order to achieve the above-described objects, according to a third aspect of the present disclosure, in a computer program stored in a computer readable medium, when an instruction of the computer program is executed, the stereogram printing content acquiring method is performed.

As described above, according to the present disclosure, a system which adjusts an altitude and a distance and captures a 3D model at various angles by combining drone and photogrammetry technologies has been developed, thereby efficiently acquiring 3D modeling data with a high fidelity.

Further, an error generated during the capturing is corrected by performing a post-processing task on the image to be utilized as a Multiview projection image and a technology which corrects shake and maintains a size consistency is applied to increase image stability, thereby producing a high quality hologram.

Further, a capturing process utilizing a drone is performed stably and efficiently and a visual quality and an availability of the resultant are increased to increase an applicability in various industrial fields.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a stereogram printing content acquiring apparatus according to an exemplary embodiment of the present disclosure;

FIG. 2 is a flowchart of a stereogram printing content acquiring method according to an exemplary embodiment;

FIGS. 3 and 4 are exemplary diagrams for explaining capturing of a photographic subject using a drone according to an exemplary embodiment;

FIGS. 5 and 6 are exemplary diagrams for explaining size adjustment of a photographic subject on a continuous image according to an exemplary embodiment; and

FIGS. 7 and 8 are exemplary diagrams for explaining correction of a center axis for a continuous image according to an exemplary embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Advantages and characteristics of the present disclosure and a method for achieving the advantages and characteristics will be clear by referring to preferable embodiments described below in detail together with the accompanying drawings. However, the present disclosure is not limited to exemplary embodiment disclosed herein but will be implemented in various forms. The exemplary embodiments are provided by way of example only so that a person of ordinary skilled in the art may fully understand the disclosures of the present disclosure and the scope of the present disclosure. Therefore, the present disclosure will be defined only by the scope of the appended claims. Like reference numerals generally denote like elements throughout the specification. “and/or” includes each of mentioned items and all combinations of one or more components.

Although the terms “first”, “second”, and the like are used for describing various element, components, and/or sections, these elements, components, and/or sections are not confined by these terms. These terms are simply used to distinguish one element, component, or sections from another element, component, or sections. Accordingly, a first element, a first component, or a first section which will be mentioned below may also be a second element, a second component, or a second section in the technical spirit of the present disclosure.

Further, in each step, numerical symbols (for example, a, b, and c) are used for the convenience of description, but do not explain the order of the steps so that unless the context apparently indicates a specific order, the order may be different from the order described in the specification. That is, the steps may occur in the exact order stated, may be performed substantially simultaneously, or may be performed in the opposite order.

The terms used in the present specification are for explaining the embodiments rather than limiting the present disclosure. Unless particularly stated otherwise in the present specification, a singular form also includes a plural form. The word “comprises” and/or “comprising” used in the present specification will be understood to imply the inclusion of stated constituents, steps, operations and/or elements but not the exclusion of any other constituents, steps, operations and/or elements.

Unless otherwise defined, all terms (including technical and scientific terms) used in the present specification may be used as the meaning which may be commonly understood by the person with ordinary skill in the art, to which the present disclosure belongs. It will be further understood that terms defined in commonly used dictionaries should not be interpreted in an idealized or excessive sense unless expressly and specifically defined.

Further, in the following description of the exemplary embodiment of the present disclosure, a detailed description of known configurations or functions incorporated herein will be omitted when it is determined that the detailed description may make the subject matter of the present disclosure unclear. Further, the terms to be described below are defined considering the functions in the exemplary embodiment of the present disclosure and may vary depending on the intention or usual practice of a user or operator. Accordingly, the terminology needs to be defined based on details throughout this specification.

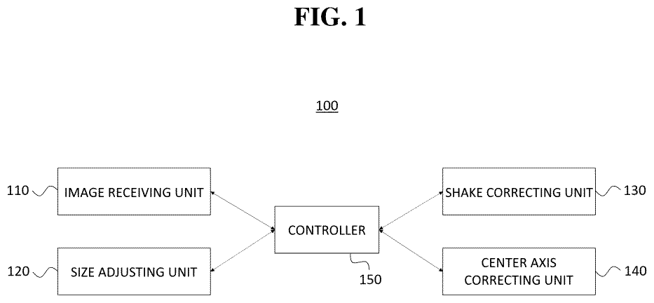

FIG. 1 is a block diagram illustrating a stereogram printing content acquiring apparatus according to an exemplary embodiment of the present disclosure.

The stereogram printing content acquiring apparatus 100 (hereinafter, simply referred to as “content acquiring apparatus”) is an apparatus for performing a stereogram printing content acquiring method according to the present disclosure and performs 3D data modeling by utilizing a drone photogrammetry. During the photogrammetry process, in order to stably match feature points, it is important to ensure an overlapping image which is easily detected regardless of the change in a size or a direction of the object. Therefore, the content acquiring apparatus 100 acquires continuous images captured by moving a camera while maintaining a constant radius using a smart flight mode of the drone, and then performs the post processing to precisely correct the image to be used as a Multiview projection image. Desirably, the content acquiring apparatus 100 performs the processes of point cloud generation, 3D mesh configuration, and texture mapping by inputting a post-processed image to photogrammetry software to be restored as 3D data. Here, the restored 3D data is used to generate a Multiview projection image using a virtual camera of Blender which is a computer graphic program and the generated Multiview projection image is subject to a rearrangement process to be converted to a hogel image, and then is produced as a digital hologram by means of a holographic stereogram printer. The present disclosure is characterized in that the image captured using a drone is post-processed to be precisely corrected to be used as a Multiview projection image so that the post-processing will be mainly described below.

Desirably, the content acquiring apparatus 100 is a computer in which an application or a program is installed and executed to perform a stereogram printing content acquiring method and includes a user interface to control input/output of the data. Here, a computer refers to all types of hardware device including at least one processor and depending on the exemplary embodiment, is understood to include a software configuration which operates in the corresponding hardware device. For example, the computer is understood to include all smartphones, tablet PCs, desktops, notebooks, and user clients and applications run in each device, but is not limited thereto.

Referring to FIG. 1, the content acquiring apparatus 100 includes an image receiving unit 110, a size adjusting unit 120, a shake correcting unit 130, a center axis correcting unit 140, and a controller 150. Here, the controller 150 controls operations and data flow of the image receiving unit 110, the size adjusting unit 120, the shake correcting unit 130, and the center axis correcting unit 140.

The image receiving unit 110 receives continuous images obtained by manually or automatically capturing a photographic subject using a drone equipped with a camera. Desirably, the image receiving unit 110 may receive the continuous images which are captured while maintaining a constant distance from the photographic subject using a smart flight mode of the drone.

The distance maintaining error and the shake generated while capturing the continuous images may be corrected by the post processing performed by the size adjusting unit 120, the shake correcting unit 130, and the center axis correcting unit 140 and the image whose error is corrected by the correcting process is utilized as a Multiview projection image.

The size adjusting unit 120 adjusts the size to be constant by comparing sizes of the photographic subjects on the continuous images.

The shake correcting unit 130 analyzes and corrects the shake of the continuous images.

The center axis correcting unit 140 corrects an error of a rotational center axis of the continuous image.

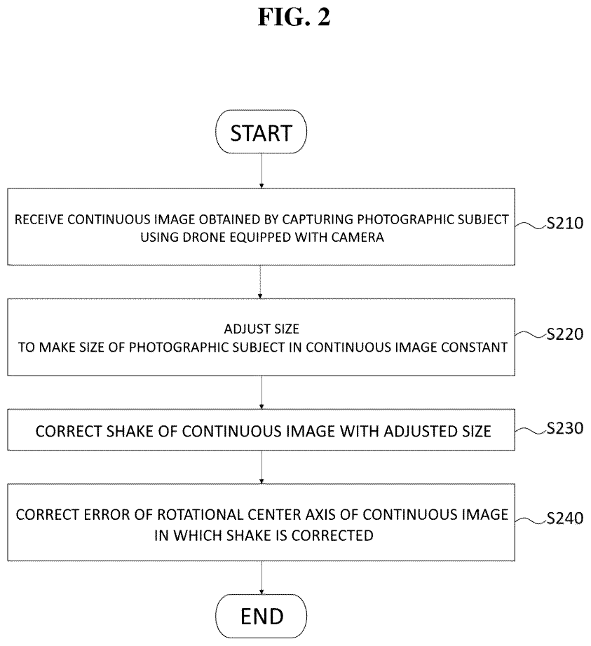

An operation performed by each configuration of the content acquiring apparatus 100 illustrated in FIG. 1 will be described in detail below with reference to FIG. 2. Although it has been described that each step which will be described with reference to FIG. 2 is performed by different configurations, it is not limited thereto, and at least some of steps may be performed by the same or different configurations, according to the exemplary embodiment.

FIG. 2 is a flowchart illustrating a stereogram printing content acquiring method according to an exemplary embodiment.

Referring to FIG. 2, the image receiving unit 110 receives continuous images obtained by capturing a photographic subject using a drone equipped with a camera in step S210. Desirably, the image receiving unit 110 receives horizontal and vertical Multiview continuous images taken at altitudes of 2 m and 4 m to increase fidelity of 3D modeling data to be utilized as photogrammetry input data and receives continuous images which are manually taken in a low altitude environment where it is difficult to use the smart flight mode of the drone to be utilized as additional photogrammetry input data.

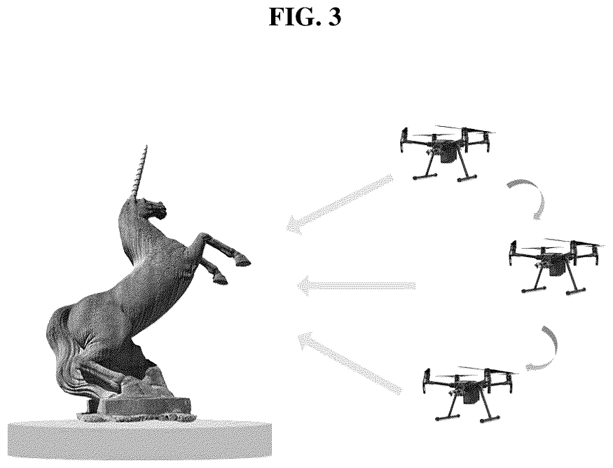

In the exemplary embodiment, the image receiving unit 110 receives continuous images obtained by manually capturing a front surface, a top surface, and a bottom surface of a photographic subject using the drone and may receive continuous images which are manually captured along left, center, and right trajectories on the bottom surface. Desirably, the drone is used to take pictures of a photographic subject corresponding to a statue or a sculpture which is 4 m or less tall and focuses on capturing optimization. Referring to FIG. 3, after sequentially capturing the front surface of the photographic subject, the drone captures a top surface of the statue by increasing the altitude and then performs the capturing the lower surface of the statue along the left, center, and right trajectories. The continuous images which have been captured as described above are received by the image receiving unit 110 and the received continuous images may be utilized as input images to generate 3D data using a photogrammetry. For example, as the drone, a phantom 4 pro may be used and the phantom 4 pro drone basically supports a progressive mode and a moving image captured by the phantom 4 pro drone is subject to an image extraction process to be converted into a JPG format. In order to acquire a high quality of 3D modeling input image, the phantom 4 pro may optimize a capturing environment by following capturing settings: A resolution is 3840×2160, a frame rate is 60p, a shutter speed is 1/320 s, an aperture is F2.8, a capturing distance is 3 m, and a capturing altitude are 1 m and 2 m.

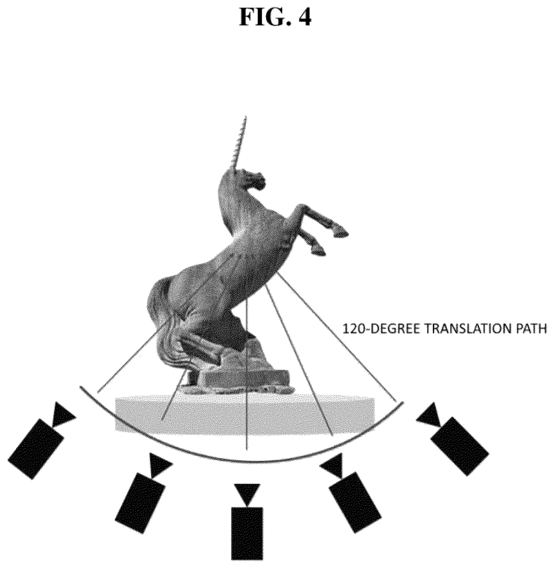

According to another exemplary embodiment, the image receiving unit 110 may receive continuous images which are automatically captured by a drone which rotates while maintaining a constant distance from the photographic subject using a point of interest (POI) mode of the drone. For example, as the drone, Mavic air 2 may be used and Mavic air 2 may perform the capturing by setting a point of interest (POI) mode as a default rather than a manual mode. Here, in order to use the POI mode, a distance between the drone and the photographic subject and the altitude are set to at least 5 m and 2 m or higher and a maximum distance and altitude may vary depending on the drone model and the environment. For example, in the present disclosure, a distance to the photographic subject is set to 5 m, an altitude is set to 2 m, and as illustrated in FIG. 4, the capturing is performed along a movement path of 120°. Desirably, in order to increase capturing fidelity, additional capturing is performed by changing the altitude to 4 m. In order to smoothly use the POI mode in Mavic air 2, the following capturing settings may be applied. A resolution is 3840×2160, a frame rate is 30P or lower, a shutter speed is 1/60 s, an aperture is f2.8, a capturing distance is 5 m, capturing altitudes are 2 m and 4 m, and a scanning method is a progressive mode.

Desirably, an image received by the image receiving unit 110 may be a continuous image which is manually or automatically captured by at least one type of drone. That is, the continuous image which is acquired to carry out the present disclosure may be captured using one type of drone and a capturing mode may be selectively determined as a manual mode or an automatic mode. In order to optimize a capturing efficiency according to a function and a capturing condition depending on a type of drone, a type of drone to be used, a number of drones, and a capturing mode including a manual or automatic mode are determined. For example, even though automatic capturing is tried by utilizing a POI mode of the phantom 4 pro, if there is a problem to acquire an image due to a GPS signal reception issue, the automatic capturing is switched to a manual capturing to acquire the image and Mavic air 2 may be used to capture continuous images. That is, the manually captured continuous image may be used for photogrammetry as a low-altitude image together with the continuous image which is automatically captured.

In order to detect a plurality of feature points from the photogrammetry regardless of a size or a direction of the object, overlapping images including the same objects are necessary. To this end, even though overlapping continuous images are captured using a POI mode of the drone, there may be a problem such as distance fluctuation or shake so that a post-processing task is performed to correct the problem. The continuous images captured using the drone may be used as an input of the photogrammetry, but is also corrected as continuous images which are used as a Multiview projection image by means of the correction of the post-processing task to be described below.

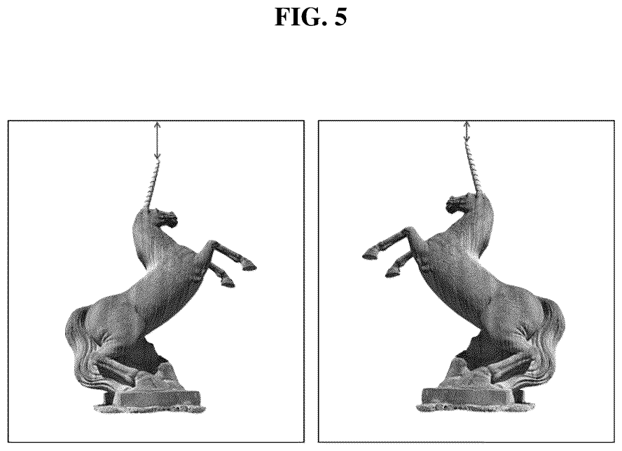

The size adjusting unit 120 adjusts a size of the photographic subject in the continuous image to be constant in step S220. Desirably, the size adjusting unit 120 compares images at a left side, a center, and a right side of the photographic subject and may find a timing at which the size of the photographic subject on the image is changed. For example, referring to FIG. 5, the size adjusting unit 120 compares images at a left side and a right side of the photographic subject and may find a timing at which the size of the photographic subject on the image is changed. That is, as illustrated in FIG. 5, the size adjusting unit 120 compares positional intervals (represented by red arrows) of the photographic subjects to find a timing at which the positional intervals do not match as a timing at which the size of the photographic subject is changed.

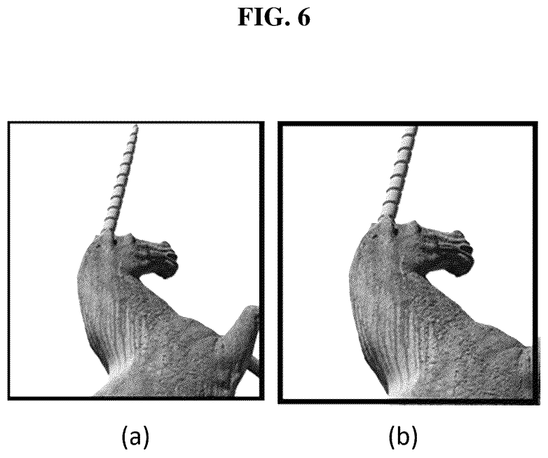

Desirably, the size adjusting unit 120 may adjust the size of the photographic subject by adding a key frame to a timing at which the size of the photographic subject is changed. That is, a clip captured with an inconsistent positional interval of the photographic subject is added to a time line to modify the image to maintain a constant interval of a top and a bottom of the photographic subject in the image. When a key frame is generated, animation is automatically generated in accordance with an amount of change to complete natural transformation. Referring to FIG. 6, FIG. 6A illustrates a size of a photographic subject before generating a key frame and FIG. 6B illustrates a size of a photographic subject after generating a key frame so that it is understood that the size of the photographic subject may be adjusted by adding a key frame.

According to an exemplary embodiment, after adjusting the size, the size adjusting unit 120 may correct colors in accordance with user input. Desirably, the size adjusting unit 120 adjusts a contrast and a chroma of an image according to information input through a user interface by a user to increase a color contrast and correct the image to be sharp and vivid.

The shake correcting unit 130 corrects the shake of the continuous images with an adjusted size in step S230. After uniformly adjusting the size of the photographic subject by the size adjusting unit 120, an operation of correcting a slight shake caused by gusts and manual operation switching is performed. The key to shake correction is to reduce unnecessary movement in the image and make the image smooth.

First, the shake correcting unit 130 analyzes a movement of the drone by analyzing a difference between frames of the continuous image and may acquire shake data based on the analyzed movement. For example, when the camera is upwardly shaken, the shake data represents how much the camera is upwardly shaken with a numerical value. To be more specific, the shake correcting unit 130 does not directly calculate the movement of the drone, that is, the camera (screen), but analyzes a difference between frames to track a movement pattern of the drone. The shake correcting unit 130 tracks feature points in the continuous image and calculates a relative position change of a specific pixel corresponding to the feature point in each frame to predict a direction and a degree of movement. The effects of translation, rotation, and enlargement or reduction caused by the drone's shake may be indirectly derived, so that even though the drone's movement is not directly calculated, the movement pattern may be identified based on pixel movement data between frames.

Desirably, the shake correcting unit 130 may set a smoothness level corresponding to a degree of shake correction. The smoothness may be optionally set by the user to finely adjust a level of shake correction and for example, may be set to a range from 0 to 100. Here, the lower the setting value, the closer the correction is to the original image, and the higher the setting value, the stronger the correction is applied. To be more specific, the shake correcting unit 130 generates an ideal path according to the acquired shake data and may adjust the movement of the drone along the ideal path. Here, the ideal path corresponds to a path along which the camera ideally moves and for example, if an original path moves sharply, the corrected path is designed to be slowly and smoothly changed. Further, the shake correcting unit 130 may leave natural shake or make completely smooth according to information about a set smoothness level.

Desirably, the shake correcting unit 130 may realign or modify a frame of the continuous image to remove the shake. The shake correcting unit 130 may correct the frame by moving, rotating, enlarging, or reducing the frame according to a type of analyzed movement of the drone. To be more specific, when the movement of the drone corresponds to translation (position), the shake correcting unit 130 moves a frame to an opposite direction by an amount that the drone moves. That is, if the image is shaken to be moved, the image is corrected to be moved to an opposite direction as much as it is shaken. For example, if the camera is shaken to the right side, the shake correcting unit 130 may correct the image by moving the frame to the left side.

Further, when the movement of the drone corresponds to translation (position), rotation, enlargement, or reduction (scale), the shake correcting unit 130 moves the frame to the opposite direction as much as it is translated, corrects the rotation as much as a rotated angle of the frame, and may correct enlarged or reduced (zoom) change of the frame. For example, if the camera is shaken to the right side and slightly rotates, the shake correcting unit 130 moves the frame to the left side and corrects the rotation to be stabilized.

Further, if the movement of the drone corresponds to perspective, the shake correcting unit 130 corrects the movement by distorting the frame using the perspective. That is, if the camera is complicatedly shaken, such as forward tilting or oblique rotation, the shake correcting unit corrects the shake by distorting the frame using the perspective.

Further, if the movement of the drone corresponds to subspace warpage, the shake correcting unit 130 may independently correct each area of the image. For example, if a left side of the screen is upwardly shaken and a right side of the screen is downwardly shaken, the shake correcting unit 130 separately corrects each area to create a totally stable image.

Desirably, the shake correcting unit 130 may process an empty space caused by realignment or distortion of the frame. If the frame is moved or rotated, an empty space may be generated in an edge (boundary) of the screen so that the empty space is processed. To be more specific, the shake correcting unit 130 may crop the screen edge so as not to generate the empty space and for example, if the empty portion is generated due to the shaken screen, the screen is cropped so that the empty area is not visible. Alternatively, the shake correcting unit 130 may scale the entire screen up as much as the empty space and for example, the image is enlarged to fill the screen, thereby hiding the empty space. Alternatively, the shake correcting unit 130 fills the empty space with surrounding pixels or interpolates (fills) the empty space based on data of preceding and subsequent frames to be looked natural. For example, a similar part of the previous frame is copied to fill a place where the empty space is generated.

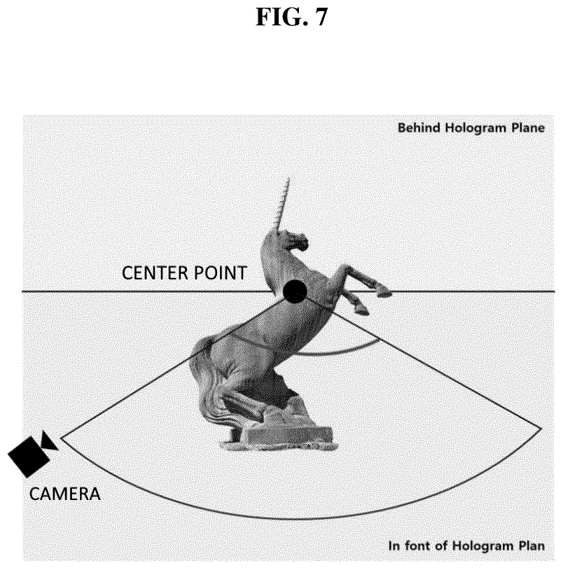

The center axis correcting unit 140 corrects an error of a rotational center axis of the continuous image in which the shake is corrected in step S240. For example, when the photographic subject is captured using the drone, if it is assumed that the rotational center axis is set as a center point as illustrated in FIG. 7, the camera moves while maintaining a predetermined distance from the center axis of the photographic subject. At this time, the rotational center axis becomes an image plane when a hogel image is generated to perform holographic stereogram printing. A subject in front of the image plane appears to protrude and a subject behind the image plane appears to recede, so that the center axis in each direction, such as a left side, a front surface, and a right side, needs to be the same to provide a unified sense of depth. An initially set rotational center axis is not maintained to cause an error and the center axis correcting unit 140 corrects the error.

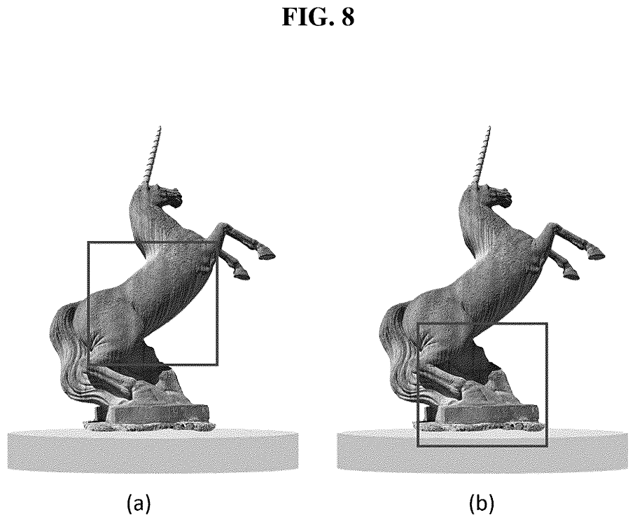

Desirably, the center axis correcting unit 140 sets a tracker to an object which is commonly seen from a first part and a last part of the center axis of the continuous image. When the continuous image is reproduced, a subject on which the tracker is disposed is tracked so that an object which is commonly seen from the first part and the last part of the continuous image needs to be set. For example, when the capturing is performed while rotating at 120° from the left side to the right side with respect to the photographic subject, there may be a problem in that a reference point set at a start point is not seen from an end point. That is, if the center axis is set as a chest of the photographic subject as illustrated with a red box in FIG. 8A, a left surface of the photographic subject disappears at the end point so that the tracker losses a target. Accordingly, as illustrated with a red box in FIG. 8B, the center axis correcting unit 140 may set a tracker at a rock which is the same vertical axis as the chest of the photographic subject which is consistently observed at the start point and the end point.

Next, the center axis correcting unit 140 tracks the target at which the tracker is set as the continuous image is reproduced and corrects a y-axis direction to make the center axis constant according to a tracking result. Desirably, if the tracker ends the tracking, the center axis correcting unit 140 performs the correction only in the y-axis direction, rather than an xy direction, to constantly maintain the center axis. That is, the center axis correcting unit 140 applies the set tracker and the correction criteria to an actual image to correct an error of the center axis and maintain constantly the central axis. Here, since the target varies according to the view point, the x-axis does not needs to be corrected. The center axis is corrected to ensure the sense of depth and consistency of the image.

Desirably, after completing the correction by the center axis correcting unit 140, the center axis correcting unit 140 may perform the rendering to output the continuous image in which the correction is completed as a file. During the rendering process, a characteristic and a format of the output file may be set and for example, set as Prores 422 HQ or H.264. Here, if the file is output as Prores 422 HQ, the conversion is performed again to finally output the file as H.264 format.

After correcting the continuous image according to the post-processing process of the present disclosure, a file with a specific format (for example, H.264) is output, the output moving image file may be converted as a continuous image file using a program, such as Gom player, Pot player. The converted continuous image file may be used as an input of the photogrammetry.

In the meantime, steps of the method or algorithm described in connection with the exemplary embodiment of the present disclosure may be directly implemented by hardware or implemented by a software module executed by the hardware or a combination thereof. The software module may reside on RAM (Random Access Memory), ROM (Read Only Memory), EPROM (Erasable Programmable ROM), EEPROM (Electrically Erasable Programmable ROM), a flash memory, a hard disk, a removable disk, a CD-ROM, or an arbitrary computer readable recording medium which is well-known in the technical field of the present disclosure.

Components of the present disclosure are implemented as a program (or an application) to be coupled to a computer which is hardware to be executed and stored in a medium. Similar to execution of the components of the present disclosure with software programming or software elements, the embodiment may be implemented by programming or scripting languages such as C, C++, Java, assembler including various algorithms implemented by a combination of data structures, processes, routines, or other program configurations. The functional aspects may be implemented by an algorithm executed in one or more processors.

The exemplary embodiments for an apparatus and a method for acquiring a stereogram printing content according to the above-described present disclosure have been explained, but the present disclosure is not limited thereto and modified in various forms within the range of claims, the detailed description of the present disclosure, and the accompanying drawings, which also belongs to the present disclosure.

What is claimed is:

1. A stereogram printing content acquiring method which is performed in a stereogram printing content acquiring apparatus, comprising:
(a) a step of receiving a continuous image which is obtained by capturing a photographic subject using a drone equipped with a camera;
(b) a step of adjusting a size to make a size of the photographic subject in the continuous image constant;
(c) a step of correcting shake of a continuous image with an adjusted size; and
(d) a step of correcting an error of a rotational center axis of the continuous image in which the shake is corrected.

2. The stereogram printing content acquiring method according to claim 1, wherein the step (a) includes:
a step of receiving a continuous image which is obtained by manually capturing a front surface, a top surface, and a bottom surface of the photographic subject using the drone; and
a step of receiving a continuous image which is manually captured along left, center, and right trajectories on the bottom surface.

3. The stereogram printing content acquiring method according to claim 1, wherein the step (a) includes:
a step of receiving continuous images which are obtained by automatically capturing the photographic subject using a point of interest (POI) flight mode of the drone while rotating with a constant distance from the photographic subject.

4. The stereogram printing content acquiring method according to claim 1, wherein the step (b) includes:
a step of comparing images at a left side, a center, and a right side of the photographic subject;
a step of finding a timing when a size of the photographic subject is changed on the image; and
a step of adjusting a size of the photographic subject by adding a key frame to the timing.

5. The stereogram printing content acquiring method according to claim 1, wherein the step (c) includes:
a step of analyzing a movement of the drone by analyzing a difference between frames of the continuous image; and
a step of realigning or modifying a frame of the continuous image according to the analyzed movement.

6. The stereogram printing content acquiring method according to claim 5, wherein the step of analyzing the movement includes:
a step of tracking a feature point in the continuous image;
a step of calculating a relative positional change of the feature point between frames of the continuous image; and
a step of predicting translation, rotation, and enlargement or reduction generated due to the shake of the drone in accordance with the calculated positional change.

7. The stereogram printing content acquiring method according to claim 6, wherein the step of realigning or modifying a frame includes:
a step of translating the frame to an opposite direction by a translated amount when the analyzed movement corresponds to the translation; and
a step of moving the frame to an opposite direction by an translated amount, correcting the rotation by an angle at which the frame rotates, and correcting the change of the enlargement or reduction of the frame when the analyzed movement corresponds to translation, rotation, and enlargement, or reduction, respectively.

8. The stereogram printing content acquiring method according to claim 6, wherein the step of realigning or modifying a frame includes:
a step of distorting and correcting the frame using perspective when the analyzed movement corresponds to perspective; and
a step of independently correcting each area of the frame when the analyzed movement corresponds to a subspace distortion.

9. The stereogram printing content acquiring method according to claim 5, wherein the step (c) further includes:
a step of setting a smoothness level corresponding to a degree of correction of shake and the step of setting a smoothness level includes:
a step of generating an ideal path according to shake data acquired based on the analyzed movement; and
a step of adjusting a movement of the drone along the ideal path.

10. The stereogram printing content acquiring method according to claim 5, wherein the step (c) further includes:
a step of processing an empty space caused by realignment or distortion of the frame, and
the step of processing an empty space includes:
a step of cropping the empty space, enlarging an entire space as much as the empty space, filling the empty space with surrounding pixels, or interpolating the empty space based on data of preceding and subsequent frames.

11. The stereogram printing content acquiring method according to claim 1, wherein the step (d) includes:
a step of setting a tracker to a target which is commonly seen from a first part and a last part of a center axis of the continuous image;
a step of tracking a target at which the tracker is set as the continuous image is reproduced;
a step of performing correction on a y-axis direction to make the center axis consistent according to the tracked result; and
a step of performing rendering after performing the correction.

12. A stereogram printing content acquiring apparatus, comprising:
an image receiving unit which receives a continuous image which is obtained by capturing a photographic subject using a drone equipped with a camera;
a size adjusting unit which adjusts a size to make a size of the photographic subject in the continuous image constant;
a shake correcting unit which corrects shake of a continuous image with an adjusted size; and
a center axis correcting unit which corrects an error of a rotational center axis of the continuous image in which the shake is corrected.

13. The stereogram printing content acquiring apparatus according to claim 12, wherein the image receiving unit receives a continuous image which is obtained by manually capturing a front surface, a top surface, and a bottom surface of the photographic subject using the drone or receives continuous images which are obtained by automatically capturing the photographic subject using a point of interest (POI) flight mode of the drone while rotating with a constant distance from the photographic subject.

14. The stereogram printing content acquiring apparatus according to claim 12, wherein the size adjusting unit compares images at a left side, a center, and a right side of the photographic subject, finds a timing on the image when a size of the photographic subject is changed, and adjusts a size of the photographic subject by adding a key frame to the timing.

15. The stereogram printing content acquiring apparatus according to claim 12, wherein the shake correcting unit analyzes a movement of the drone by analyzing a difference between frames of the continuous image and realigns or modifies a frame of the continuous image according to the analyzed movement.

16. The stereogram printing content acquiring apparatus according to claim 15, wherein the shake correcting unit sets a smoothness level corresponding to a correction degree of shake, and the smoothness level is set by generating an ideal path according to shake data acquired based on the analyzed movement and adjusting a movement of the drone along the ideal path.

17. The stereogram printing content acquiring apparatus according to claim 15, wherein the shake correcting unit processes an empty space caused by realignment or distortion of the frame and the empty space is processed by cropping the empty space, enlarging an entire space as much as the empty space, filling the empty space with surrounding pixels, or interpolating the empty space based on data of preceding and subsequent frames.

18. The stereogram printing content acquiring apparatus according to claim 12, wherein the center axis correcting unit sets a tracker to a target which is commonly seen from a first part and a last part of a center axis of the continuous image, tracks a target at which the tracker is set as the continuous image is reproduced, performs correction on a y-axis direction to make the center axis consistent according to the tracked result, and performs rendering after performing the correction.

19. A computer program stored in a computer readable medium, wherein when an instruction of the computer program is executed, the method according to claim 1 is performed.
